(19) United States
(12) Patent Application Publication
(10) Pub. No.: US 2007/0211402 A1
(43) Pub. Date: Sep. 13, 2007

(54) SUBSTRATE PROCESSING APPARATUS, SUBSTRATE ATTRACTING METHOD, AND STORAGE MEDIUM

(75) Inventors: Masayuki Sawataishi, Nirasaki-shi (JP); Akitaka Shimuzu, Nirasaki-shi (JP); Eiichi Nishimura, Nirasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/674,843

(22) Filed: Feb. 14, 2007

Related U.S. Application Data
(60) Provisional application No. 60/783,843, filed on Mar. 21, 2006.

(30) Foreign Application Priority Data
Mar. 8, 2006 (JP) 2006-062884

(51) Int. Cl. H01T 23/00

(52) U.S. Cl. 361/234

(57) ABSTRACT

A substrate processing apparatus carrying out processing on a substrate, which enables attachment of particles to a surface of a substrate to be prevented. A substrate processing apparatus comprises a housing chamber in which the substrate is housed, and a stage that is disposed in the housing chamber and on which the substrate is mounted. The stage having in an upper portion thereof an electrostatic chuck comprising an insulating member having an electrode plate therein, and the electrode plate having a DC power source connected thereto. The DC power source applies a negative voltage to the electrode plate when the substrate is to be attracted by the electrostatic chuck.

### BACKGROUND OF THE INVENTION

1. Field of the Invention

The present invention relates to a substrate processing apparatus, a substrate attracting method, and a storage medium, and in particular relates to a substrate processing apparatus having therein an electrostatic chuck that attracts a substrate.

2. Description of the Related Art

A substrate processing apparatus that carries out plasma processing such as etching processing on wafers as substrates has a housing chamber in which a wafer is housed, and a stage that is disposed in the housing chamber and on which the wafer is mounted. In such a substrate processing apparatus, plasma is produced in the housing chamber, and the wafer is subjected to the etching processing by the plasma.

The stage has in an upper portion thereof an electrostatic chuck comprised of an insulating member having an electrode plate therein, the wafer being mounted on the electrostatic chuck. While the wafer is being subjected to the etching processing, a DC voltage is applied to the electrode plate, the electrostatic chuck attracting the wafer thereto through a Coulomb force or a Johnsen-Rahbek force generated by the DC voltage.

Common types of electrostatic chuck are a bipolar type having two or more electrode plates therein, and a unipolar type having one electrode plate therein. The wafer is attracted by producing a potential difference between the two or more electrode plates in the bipolar type electrostatic chuck (see, for example, Japanese Laid-open Patent Publication (Kokai) No. H05-190654 and Japanese Laid-open Patent Publication (Kokai) No. H10-270539), and by producing a potential difference between the electrode plate and the wafer in the unipolar type electrostatic chuck.

However, when the electrostatic chuck attracts the wafer thereto, if an excessive positive DC voltage is applied to the electrode plate, then an arc discharge which is a local DC discharge may be produced from a peripheral portion (an edge) of the attracted wafer or from a focus ring disposed surrounding the electrostatic chuck. With such an arc discharge, energy is concentrated at the destination of the discharge, for example an inner wall surface of the housing chamber, and hence deposit attached to the inner wall surface of the housing chamber is detached and scattered around to form particles. The particles may become attached to a surface of the wafer, causing defects in semiconductor devices manufactured from the wafer.

### SUMMARY OF THE INVENTION

It is an object of the present invention to provide a substrate processing apparatus which enables attachment of particles to a surface of a substrate to be prevented, a substrate attracting method, and a storage medium.

To attain the above object, in a first aspect of the present invention, there is provided a substrate processing apparatus that carries out processing on a substrate, comprising a housing chamber in which the substrate is housed, and a stage that is disposed in the housing chamber and on which the substrate is mounted, the stage having in an upper portion thereof an electrostatic chuck comprising an insulating member having an electrode plate therein, and the electrode plate having a DC power source connected thereto, wherein the DC power source applies a negative voltage to the electrode plate when the substrate is to be attracted by the electrostatic chuck.

According to the above construction, the DC power source applies a negative voltage to the electrode plate when the substrate is to be attracted by the electrostatic chuck. When the negative voltage is applied to the electrode plate, the form of a discharge from a peripheral portion of the substrate attracted by the electrostatic chuck or a housing chamber internal component disposed around the substrate is a glow discharge which is not a local DC discharge. With such a glow discharge, energy is not concentrated at the destination of the discharge, and hence deposit is not detached and scattered around from an inner wall surface of the housing chamber, and thus particles are not produced. Moreover, when the negative voltage is applied to the electrode plate, a potential of a front surface of the substrate, which is the surface on the opposite side to the electrostatic chuck, becomes negative. If the particles are negatively charged, then the particles thus receive a repulsive force from the front surface of the substrate. As a result of the above, attachment of particles to the front surface of the substrate can be prevented.

Preferably, the DC power source applies a positive voltage to the electrode plate when the substrate is to be detached by the electrostatic chuck, a value of the positive voltage being not more than 1500 V.

According to the above construction, the DC power source applies a positive voltage to the electrode plate when the substrate is to be detached by the electrostatic chuck, a value of the positive voltage being not more than 1500 V. When the substrate has been attracted to the electrostatic chuck by applying a negative voltage to the electrode plate, upon applying the positive voltage to the electrode plate, a repulsive force acts between the substrate and the electrostatic chuck, and hence the substrate is detached from the electrostatic chuck. At this time, because the value of the positive voltage is not more than 1500 V, an arc discharge which is a local DC discharge is hardly produced as the discharge form. As a result, when the substrate is detached from the electrostatic chuck, attachment of particles to the front surface of the substrate can again be prevented.

Preferably, a high frequency power source is connected to the stage, and the high frequency power source applies high frequency electrical power to the stage before the DC power source applies the negative voltage to the electrode plate.

According to the above construction, the high frequency power source connected to the stage applies high frequency electrical power to the stage before the DC power source applies the negative voltage to the electrode plate. When the high frequency electrical power is applied to the stage, a sheath is produced over the stage. The sheath drives negatively charged particles away from above the substrate mounted on the stage. As a result, even if particles are produced in the housing chamber, attachment of the particles to the front surface of the substrate can be reliably prevented.

Preferably, the substrate has a polysilicon layer formed on a front surface thereof, and the processing is etching processing.

To attain the above object, in a second aspect of the present invention, there is provided a substrate attracting method for a substrate processing apparatus comprising a housing chamber in which a substrate is housed, and a stage that is disposed in the housing chamber and on which the substrate is mounted, the stage having in an upper portion thereof an electrostatic chuck comprising an insulating member having an electrode plate therein, and the electrode plate having a DC power source connected thereto, the substrate attracting method having a negative voltage application step of the DC power source applying a negative voltage to the electrode plate when the substrate is to be attracted by the electrostatic chuck.

Preferably, the substrate attracting method has a positive voltage application step of the DC power source applying a positive voltage to the electrode plate when the substrate is to be detached by the electrostatic chuck, a value of the positive voltage being not more than 1500 V.

Preferably, the substrate attracting method as claimed has a high frequency electrical power application step of a high frequency power source connected to the stage applying high frequency electrical power to the stage before the DC power source applies the negative voltage to the electrode plate.

To attain the above object, in a third aspect of the present invention, there is provided a computer-readable storage medium storing a program for causing a computer to implement a substrate attracting method for a substrate processing apparatus comprising a housing chamber in which a substrate is housed, and a stage that is disposed in the housing chamber and on which the substrate is mounted, the stage having in an upper portion thereof an electrostatic chuck comprising an insulating member having an electrode plate therein, and the electrode plate having a DC power source connected thereto, the program having a negative voltage application module for the DC power source applying a negative voltage to the electrode plate when the substrate is to be attracted by the electrostatic chuck.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate an embodiment of the present invention and, together with the description, serve to explain the principles of the present invention.

FIG. 1 is a sectional view of a substrate processing apparatus according to an embodiment of the present invention;

FIG. 2 is a graph showing the relationship between the value of a positive voltage applied to an electrode plate of the substrate processing apparatus shown in FIG. 1, and a number of particles counted; and

FIG. 3 is a diagram showing a high frequency electrical power and DC electrical power application sequence in a substrate attracting method according to the present embodiment.

### DETAILED DESCRIPTION OF THE PREFERRED EMBODIMENTS

Preferred embodiments of the present invention will be described in detail below with reference to the drawings.

First, a substrate processing apparatus according to an embodiment of the present invention will be described.

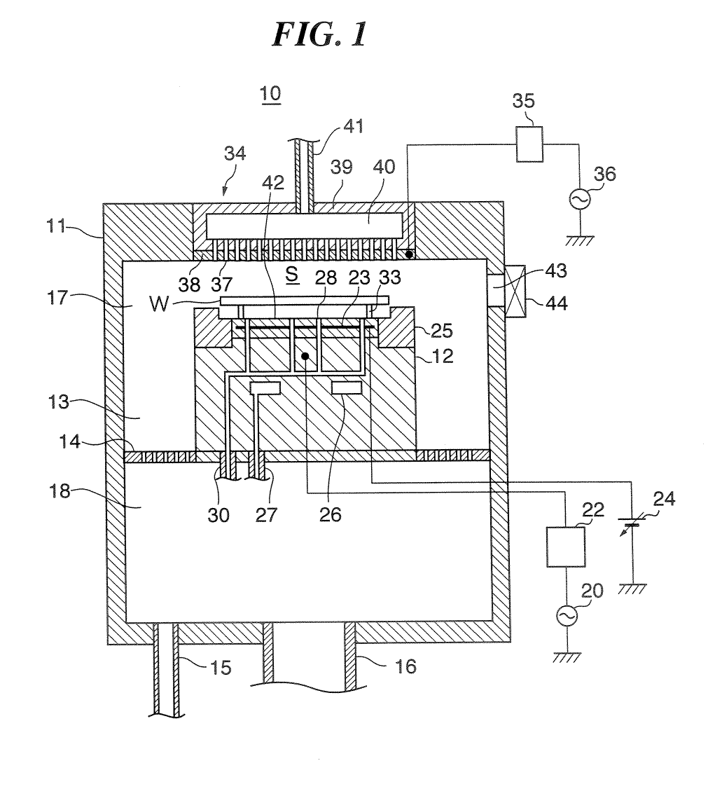

FIG. 1 is a sectional view schematically showing the construction of the substrate processing apparatus according to the present embodiment. The substrate processing apparatus is constructed such as to carry out etching processing on a polysilicon layer formed on a semiconductor wafer as a substrate.

As shown in FIG. 1, the substrate processing apparatus 10 has a chamber 11 (housing chamber) in which is housed a semiconductor wafer (hereinafter referred to merely as a “wafer”) W having a diameter of, for example, 300 mm. A cylindrical susceptor 12 is disposed in the chamber 11 as a stage on which the wafer is mounted. In the substrate processing apparatus 10, a side exhaust path 13 that acts as a flow path through which gas above the susceptor 12 is exhausted out of the chamber 11 is formed between an inner wall of the chamber 11 and a side face of the susceptor 12. A baffle plate 14 is disposed part way along the side exhaust path 13. An inner wall surface of the chamber 11 is covered with quartz or yttria (Y₂O₃)

The baffle plate 14 is a plate-shaped member having a large number of holes therein, and acts as a partitioning plate that partitions the chamber 11 into an upper portion and a lower portion. Plasma, described below, is produced in the upper portion (hereinafter referred to as the “reaction chamber”) 17 of the chamber 11 partitioned by the baffle plate 14. Moreover, a roughing exhaust pipe 15 and a main exhaust pipe 16 that exhaust gas out from the chamber 11 are provided in the lower portion (hereinafter referred to as the “manifold”) 18 of the chamber 11. The roughing exhaust pipe 15 has a DP (dry pump) (not shown) connected thereto, and the main exhaust pipe 16 has a TMP (turbo-molecular pump) (not shown) connected thereto. Moreover, the baffle plate 14 captures or reflects ions and radicals produced in a processing space S, described below, in the reaction chamber 17, thus preventing leakage of the ions and radicals into the manifold 18.

The roughing exhaust pipe 15, the main exhaust pipe 16, the DP, and the TMP together constitute an exhausting apparatus. The roughing exhaust pipe 15 and the main exhaust pipe 16 exhaust gas in the reaction chamber 17 out of the chamber 11 via the manifold 18. Specifically, the roughing exhaust pipe 15 reduces the pressure in the chamber 11 from atmospheric pressure down to a low vacuum state, and the main exhaust pipe 16 is operated in collaboration with the roughing exhaust pipe 15 to reduce the pressure in the chamber 11 from atmospheric pressure down to a high vacuum state (e.g. a pressure of not more than 133 Pa (1 Torr)), which is at a lower pressure than the low vacuum state.

A lower high frequency power source 20 is connected to the susceptor 12 via a matcher 22. The lower high frequency power source 20 applies predetermined high frequency electrical power to the susceptor 12. The susceptor 12 thus acts as a lower electrode. The matcher 22 reduces reflection of the high frequency electrical power from the susceptor 12 so as to maximize the efficiency of the supply of the high frequency electrical power into the susceptor 12.

A disk-shaped electrostatic chuck 42 comprised of an insulating member having an electrode plate 23 therein is provided in an upper portion of the susceptor 12. When a wafer W is mounted on the susceptor 12, the wafer W is disposed on the electrostatic chuck 42. A DC power source 24 is electrically connected to the electrode plate 23. Upon a negative high DC voltage (hereinafter referred to as a “negative voltage”) being applied to the electrode plate 23, a positive potential is produced on a surface (hereinafter referred to as the “rear surface”) of the wafer W on the electrostatic chuck 42 side, and a negative potential is produced on a surface (hereinafter referred to as the “front surface”) of the wafer W on the opposite side to the electrostatic chuck 42. A potential difference thus arises between the electrode plate 23 and the rear surface of the wafer W, and hence the wafer W is attracted to and held on an upper surface of the electrostatic chuck 42 through a Coulomb force or a Johnsen-Rahbek force due to the potential difference.

Moreover, an annular focus ring 25 is provided on an upper portion of the susceptor 12 so as to surround the wafer W attracted to and held on the upper surface of the electrostatic chuck 42. The focus ring 25 is exposed to the processing space S, and focuses plasma in the processing space S toward the front surface of the wafer W, thus improving the efficiency of the etching processing.

An annular coolant chamber 26 that extends, for example, in a circumferential direction of the susceptor 12 is provided inside the susceptor 12. A coolant, for example cooling water or a Galden fluid, at a predetermined temperature is circulated through the coolant chamber 26 via coolant piping 27 from a chiller unit (not shown). A processing temperature of the wafer W attracted to and held on the upper surface of the electrostatic chuck 42 is controlled through the temperature of the coolant.

A plurality of heat-transmitting gas supply holes 28 are provided in a portion of the upper surface of the electrostatic chuck 42 on which the wafer W is attracted and held (hereinafter referred to as the “attracting surface”). The heat-transmitting gas supply holes 28 are connected to a heat-transmitting gas supply unit (not shown) by a heat-transmitting gas supply line 30. The heat-transmitting gas supply unit supplies helium (He) gas as a heat-transmitting gas via the heat-transmitting gas supply holes 28 into a gap between the attracting surface of the susceptor 12 and the rear surface of the wafer W. The helium gas supplied into the gap between the attracting surface of the susceptor 12 and the rear surface of the wafer W transmits heat from the wafer W to the susceptor 12.

A plurality of pusher pins 33 are provided in the attracting surface of the susceptor 12 as lifting pins that can be made to project out from the upper surface of the electrostatic chuck 42. The pusher pins 33 are connected to a motor by a ball screw (neither shown), and can be made to project out from the attracting surface of the susceptor 12 through rotational motion of the motor, which is converted into linear motion by the ball screw. The pusher pins 33 are housed inside the susceptor 12 when a wafer W is being attracted to and held on the attracting surface of the susceptor 12 so that the wafer W can be subjected to the etching processing, and are made to project out from the upper surface of the electrostatic chuck 42 so as to lift the wafer W up away from the susceptor 12 when the wafer W is to be transferred out from the chamber 11 after having been subjected to the etching processing.

A gas introducing shower head 34 is disposed in a ceiling portion of the chamber 11 such as to face the susceptor 12. An upper high frequency power source 36 is connected to the gas introducing shower head 34 via a matcher 35. The upper high frequency power source 36 applies predetermined high frequency electrical power to the gas introducing shower head 34. The gas introducing shower head 34 thus acts as an upper electrode. The matcher 35 has a similar function to the matcher 22, described earlier.

The gas introducing shower head 34 has a ceiling electrode plate 38 having a large number of gas holes 37 therein, and an electrode support 39 on which the ceiling electrode plate 38 is detachably supported. A buffer chamber 40 is provided inside the electrode support 39. A processing gas introducing pipe 41 is connected to the buffer chamber 40. A processing gas, for example a mixed gas of a brominated gas or a chlorinated gas having O₂ gas and an inert gas such as He added thereto, supplied from the processing gas introducing pipe 41 into the buffer chamber 40 is supplied by the gas introducing shower head 34 into the reaction chamber 17 via the gas holes 37.

A transfer port 43 for the wafers W is provided in a side wall of the chamber 11 in a position at the height of a wafer W that has been lifted up from the susceptor 12 by the pusher pins 33. A gate valve 44 for opening and closing the transfer port 43 is provided in the transfer port 43.

Radio frequency electrical power is applied to the susceptor 12 and the gas introducing shower head 34 in the reaction chamber 17 of the substrate processing apparatus 10 as described above so as to apply high frequency electrical power into the processing space S between the susceptor 12 and the gas introducing shower head 34, whereupon the processing gas supplied into the processing space S from the gas introducing shower head 34 is turned into high-density plasma, whereby ions and radicals are produced; the wafer W is subjected to the etching processing by the ions and so on.

Operation of the component elements of the substrate processing apparatus 10 described above is controlled in accordance with a program for the etching processing by a CPU of a control unit (not shown) of the substrate processing apparatus 10.

Note that the construction of the substrate processing apparatus 10 described above is the same as that of a conventional substrate processing apparatus.

Prior to the present invention, to investigate the relationship between the polarity and magnitude of the DC voltage applied to the electrode plate and the number of particles produced, using the substrate processing apparatus 10, the present inventors have alternately applied a positive high DC voltage (hereinafter referred to as a “positive voltage”) and a negative voltage to the electrode plate 23 from the DC power source 24 while introducing a large amount of N₂ gas into the reaction chamber 17 from the gas introducing shower head 34 and a separate purging pipe (not shown). At this time, the value of the negative voltage was set to −3000 V, and the value of the positive voltage was varied. Note that a wafer W was not mounted on the susceptor 12.

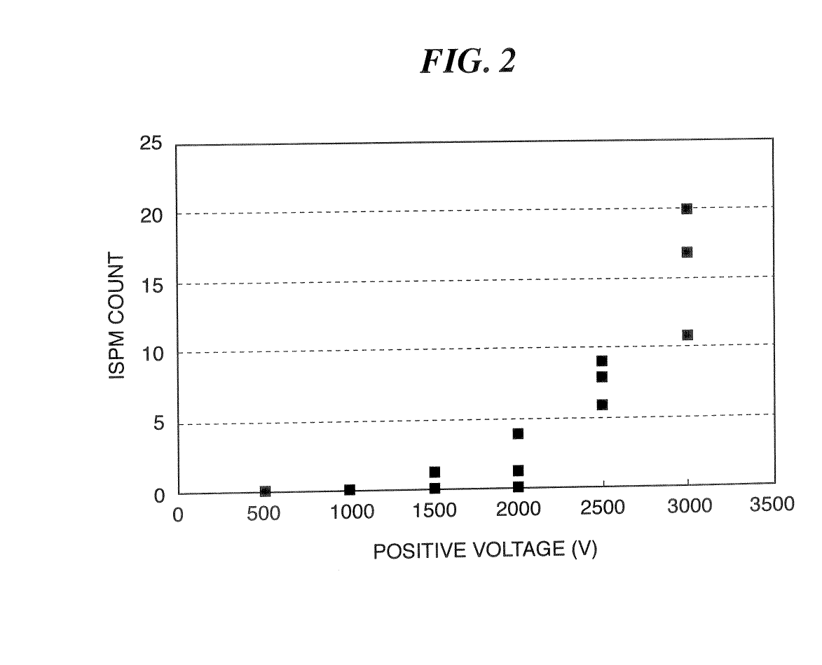

At this time, the present inventors counted the number of particles produced in the reaction chamber 17 and exhausted out of the chamber 11 via the roughing exhaust pipe 15 using a particle monitor (ISPM). Moreover, from an observation window (not shown) provided in the side wall of the chamber 11, the present inventors observed the discharge form of a DC discharge from the electrostatic chuck 42 or the first processing unit 25 toward the quartz or yttria covering the inner wall surface of the chamber 11. The observed discharge form is shown in Table 1, and the counted number of particles is shown on a graph in FIG. 2.

TABLE 1

| | | DISCHARGE | DISCHARGE |
|---|---|---|---|
| | | FORM WHEN | FORM WHEN |
| NEGATIVE | POSITIVE | NEGATIVE | POSITIVE |
| VOLTAGE | VOLTAGE | VOLTAGE | VOLTAGE |
| (V) | (V) | APPLIED | APPLIED |
| 3000 | 3000 | GLOW | ARC |
| 3000 | 2500 | GLOW | ARC |
| 3000 | 2000 | GLOW | ARC |
| 3000 | 1500 | GLOW | ARC & GLOW |
| 3000 | 1000 | GLOW | ARC & GLOW |
| 3000 | 500 | GLOW | ARC & GLOW |

As shown in Table 1, it was found that if the value of the positive voltage is made to be low, then the discharge form when the positive voltage is applied changes from an arc discharge which is a local DC discharge to a glow discharge which is not a local DC discharge. Moreover, it was found that the discharge form when the negative voltage is applied is a glow discharge which is not a local DC discharge. Furthermore, as shown by the graph in FIG. 2, it was found that if the value of the positive voltage is made to be low, then the number of particles exhausted out of the chamber 11 via the exhaust pipe 15, i.e. the number of particles produced in the reaction chamber 17 is reduced. Specifically, it was found that if the value of the positive voltage is not more than 1500 V, then particles are hardly produced at all in the reaction chamber 17.

Regarding the mechanism by which the number of particles produced is reduced when the value of the positive voltage is made to be low, as a result of observing the discharge form when the positive voltage is applied, the present inventors have come up with the following hypothesis.

That is, if the positive voltage is made to be low, then the discharge form of the DC discharge from the electrostatic chuck 42 or the like toward the inner wall surface of the chamber 11 changes to a glow discharge. With a glow discharge, energy is not concentrated at the inner wall surface of the chamber 11 that is the destination of the discharge, and hence deposit attached to the inner wall surface is not detached and scattered around. The number of particles produced in the reaction chamber 17 is thus reduced.

Furthermore, the present inventors have inferred that, because the discharge form when the negative voltage is applied is a glow discharge, if a wafer W is attracted to the electrostatic chuck 42 by applying a negative voltage to the electrode plate 23, then even if a DC discharge is produced from a peripheral portion of the wafer W or the like toward the inner wall surface of the chamber 11, production of particles in the reaction chamber 17 can be suppressed.

The present invention is based on the above findings.

A substrate attracting method according to an embodiment of the present invention will now be described.

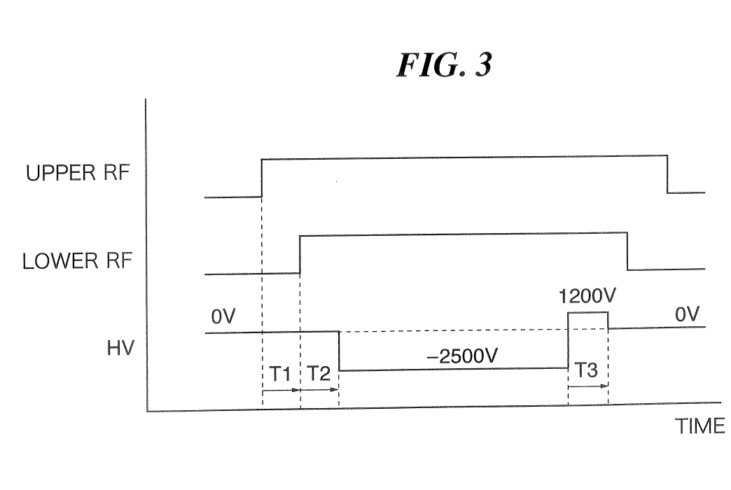

FIG. 3 is a diagram showing a high frequency electrical power and DC electrical power application sequence in the substrate attracting method according to the present embodiment.

As shown in FIG. 3, after a wafer W having a polysilicon layer formed on a front surface thereof has been transferred into the chamber 11 and mounted on the electrostatic chuck 42 of the susceptor 12, and the pressure in the chamber 11 has been reduced from atmospheric pressure down to a high vacuum state by the exhausting apparatus described above, first, predetermined high frequency electrical power (upper RF) is applied to the gas introducing shower head 34 by the upper high frequency power source 36, and then after a time period T1 has elapsed, predetermined high frequency electrical power (lower RF) is applied to the susceptor 12 by the lower high frequency power source lower high frequency power source 20. At this time, high frequency electrical power is applied into the processing space S from the gas introducing shower head 34 and the susceptor 12, and hence plasma is produced from the processing gas in the processing space S. The plasma is neutrally charged, and hence the numbers of electrons and positive ions are equal. However, because the electrons are lighter in weight than the positive ions, in the vicinity of the wafer W on the electrostatic chuck 42, the electrons reach the wafer W more quickly. As a result, a sheath, which is a region in which there are very few electrons, is produced close to the wafer W. Because the sheath is a region in which there are few electrons, the sheath is positively charged overall. Moreover, it is known that particles are generally negatively charged. The sheath thus applies a repulsive force to particles heading toward the wafer W, so as to decelerate the particles, and drive the particles away from above the wafer W.

After a time period T2 has elapsed, the DC power source 24 then applies a negative voltage (−HV: negative high voltage) of, for example, −2500 V to the electrode plate 23. At this time, a positive potential is produced on the rear surface of the wafer W, and hence a potential difference arises between the electrode plate 23 and the rear surface of the wafer W, whereby the wafer W is attracted to and held on the upper surface of the electrostatic chuck 42 through a Coulomb force or a Johnsen-Rahbek force due to the potential difference. Upon the negative voltage being applied to the electrode plate 23, the form of a discharge from the peripheral portion of the wafer W or the like is a glow discharge, and hence energy is not concentrated at the inner wall surface of the chamber 11 that is the destination of the discharge, and thus deposit attached to the inner wall surface is not detached and scattered around. Moreover, a negative potential is produced on the front surface of the wafer W, and hence the negatively charged particles also receive a repulsive force from the front surface of the wafer W, and are thus driven away from above the wafer W.

Next, while the polysilicon layer on the wafer W is being subjected to the etching processing, the DC power source 24 continues to apply the negative voltage to the electrode plate 23. Once the etching processing has been completed, the DC power source 24 applies a positive voltage (+HV: positive high voltage) of, for example, +1200 V to the electrode plate 23. Because a positive potential has been produced on the rear surface of the wafer W, a repulsive force now acts between the wafer W and the electrode plate 23, and hence the wafer W is detached from the electrostatic chuck 42. Moreover, because the value of the positive voltage applied to the electrode plate 23 when detaching the wafer W from the electrostatic chuck 42 is +1200 V, an arc discharge is hardly produced (see Table 1), and particles are not produced in the reaction chamber 17 (see FIG. 2).

After a time period T3 has elapsed, the application of the voltage from the DC power source 24 to the electrode plate 23 is then stopped.

According to the application sequence shown in FIG. 3, the DC power source 24 applies a negative voltage to the electrode plate 23 when a wafer W is to be attracted by the electrostatic chuck 42. When the negative voltage is applied to the electrode plate 23, the form of a discharge from the peripheral portion of the wafer W or the first processing unit 25 is a glow discharge. With such a glow discharge, energy is not concentrated at the destination of the discharge, and hence deposit is not detached and scattered around from the inner wall surface of the chamber 11 that is the destination of the discharge, and thus particles are not produced. Moreover, when the negative voltage is applied to the electrode plate 23, a negative potential is produced on the front surface of the wafer W, and hence negatively charged particles receive a repulsive force from the front surface of the wafer W. As a result of the above, when the wafer W is attracted by the electrostatic chuck 42, attachment of particles to the front surface of the wafer W can be prevented.

According to the application sequence shown in FIG. 3, the DC power source 24 applies a positive voltage to the electrode plate 23 when the wafer W is to be detached by the electrostatic chuck 42, the value of the positive voltage being +1200 V. Because the value of the positive voltage is not more than 1500 V, an arc discharge which is a local DC discharge is hardly produced as the discharge form, and hence particles are hardly produced at all in the reaction chamber 17. As a result, when the wafer W is detached from the electrostatic chuck 42, attachment of particles to the front surface of the wafer W can again be prevented.

Moreover, according to the application sequence shown in FIG. 3, the lower high frequency power source 20 connected to the susceptor 12 applies high frequency electrical power to the susceptor 12 before the DC power source 24 applies the negative voltage to the electrode plate 23. When the high frequency electrical power is applied to the susceptor 12, a sheath is produced over the susceptor 12. The sheath drives negatively charged particles away from above the wafer W. As a result, even if particles are produced in the reaction chamber 17, attachment of the particles to the front surface of the wafer W can be reliably prevented.

The substrates subjected to the etching processing or the like in the substrate processing apparatus 10 described above are not limited to being semiconductor wafers, but rather may alternatively be any of various substrates used in LCDs (liquid crystal displays), FPDs (flat panel displays) or the like, or photomasks, CD substrates, printed substrates, or the like.

Moreover, it is to be understood that the object of the present invention may also be accomplished by supplying the apparatus with a storage medium in which is stored a program code of software that realizes the functions of the embodiment described above, and then causing a computer (or CPU, MPU, etc.) of the apparatus to read out and execute the program code stored in the storage medium.

In this case, the program code itself read out from the storage medium realizes the functions of the embodiment described above, and hence the program code and the storage medium storing the program code constitute the present invention.

The storage medium for supplying the program code may be, for example, a floppy (registered trademark) disk, a hard disk, a magnetic-optical disk, an optical disk such as a CD-ROM, a CD-R, a CD-RW, a DVD-ROM, a DVD-RAM, a DVD-RW, or a DVD+RW, a magnetic tape, a nonvolatile memory card, or a ROM. Alternatively, the program code may be downloaded via a network.

Moreover, it is to be understood that the functions of the embodiment described above can be realized not only by executing a program code read out by a computer, but also by causing an OS (operating system) or the like which operates on the computer to perform a part or all of the actual operations based on instructions of the program code.

Furthermore, it is to be understood that the functions of the embodiment described above may also be accomplished by writing a program code read out from a storage medium into a memory provided on an expansion board inserted into a computer or in an expansion unit connected to the computer and then causing a CPU or the like provided on the expansion board or in the expansion unit to perform a part or all of the actual operations based on instructions of the program code.

### WORKING EXAMPLE

Next, a working example of the present invention will be described in detail.

### WORKING EXAMPLE

First, a wafer for counting particles (hereinafter referred to as the “particle wafer”) was prepared, and was transferred into the chamber 11 of the substrate processing apparatus 10 and mounted on the electrostatic chuck 42 of the susceptor 12. Next, predetermined high frequency electrical power was applied to the gas introducing shower head 34 from the upper high frequency power source 36, and predetermined high frequency electrical power was applied to the susceptor 12 from the lower high frequency power source 20, thus producing plasma in the processing space S.

After that, a negative voltage of −2500 V was applied to the electrode plate 23 from the DC power source 24 so as to attract the particle wafer to the electrostatic chuck 42, and then after a predetermined time period had elapsed, a positive voltage of +1200 V was applied to the electrode plate 23 from the DC power source 24 so as to detach the particle wafer from the electrostatic chuck 42.

Next, the particle wafer was transferred out from the chamber 11, and was transferred into a surfscan type particle counter. After that, the number of particles per unit area on the front surface of the particle wafer was counted. The mean value of the counted number of particles was 31.

### COMPARATIVE EXAMPLE

As in the working example, a particle wafer was mounted on the electrostatic chuck 42, and predetermined high frequency electrical power was applied to each of the gas introducing shower head 34 and the susceptor 12 from the upper high frequency power source 36 and the lower high frequency power source 20, thus producing plasma in the processing space S.

After that, a positive voltage of +2500 V was applied to the electrode plate 23 from the DC power source 24 so as to attract the particle wafer to the electrostatic chuck 42, and then after a predetermined time period had elapsed, a negative voltage of −1200 V was applied to the electrode plate 23 from the DC power source 24 so as to detach the particle wafer from the electrostatic chuck 42.

Next, the number of particles per unit area on the front surface of the particle wafer was counted as in the working example. The mean value of the counted number of particles was 328.

Comparing the working example and the comparative example, it can be seen that attachment of particles to the front surface of a wafer can be prevented if the wafer is attracted to the electrostatic chuck 42 by applying a negative voltage to the electrode plate 23.

The above-described embodiments are merely exemplary of the present invention, and are not be construed to limit the scope of the present invention.

The scope of the present invention is defined by the scope of the appended claims, and is not limited to only the specific descriptions in this specification. Furthermore, all modifications and changes belonging to equivalents of the claims are considered to fall within the scope of the present invention.

What is claimed is:

1. A substrate processing apparatus that carries out processing on a substrate, comprising a housing chamber in which the substrate is housed, and a stage that is disposed in said housing chamber and on which the substrate is mounted, said stage having in an upper portion thereof an electrostatic chuck comprising an insulating member having an electrode plate therein, and said electrode plate having a DC power source connected thereto, wherein
said DC power source applies a negative voltage to said electrode plate when the substrate is to be attracted by said electrostatic chuck.

2. A substrate processing apparatus as claimed in claim 1, wherein said DC power source applies a positive voltage to said electrode plate when the substrate is to be detached by said electrostatic chuck, a value of the positive voltage being not more than 1500 V.

3. A substrate processing apparatus as claimed in claim 1, wherein a high frequency power source is connected to said stage, and said high frequency power source applies high frequency electrical power to said stage before said DC power source applies the negative voltage to said electrode plate.

4. A substrate processing apparatus as claimed in claim 2, wherein a high frequency power source is connected to said stage, and said high frequency power source applies high frequency electrical power to said stage before said DC power source applies the negative voltage to said electrode plate.

5. A substrate processing apparatus as claimed in claim 1, wherein the substrate has a polysilicon layer formed on a front surface thereof, and the processing is etching processing.

6. A substrate processing apparatus as claimed in claim 2, wherein the substrate has a polysilicon layer formed on a front surface thereof, and the processing is etching processing.

7. A substrate processing apparatus as claimed in claim 3, wherein the substrate has a polysilicon layer formed on a front surface thereof, and the processing is etching processing.

8. A substrate processing apparatus as claimed in claim 4, wherein the substrate has a polysilicon layer formed on a front surface thereof, and the processing is etching processing.

9. A substrate attracting method for a substrate processing apparatus comprising a housing chamber in which a substrate is housed, and a stage that is disposed in the housing chamber and on which the substrate is mounted, the stage having in an upper portion thereof an electrostatic chuck comprising an insulating member having an electrode plate therein, and the electrode plate having a DC power source connected thereto, the substrate attracting method having
a negative voltage application step of the DC power source applying a negative voltage to the electrode plate when the substrate is to be attracted by the electrostatic chuck.

10. A substrate attracting method as claimed in claim 9, having a positive voltage application step of the DC power source applying a positive voltage to the electrode plate when the substrate is to be detached by the electrostatic chuck, a value of the positive voltage being not more than 1500 V.

11. A substrate attracting method as claimed in claim 9, having a high frequency electrical power application step of a high frequency power source connected to the stage applying high frequency electrical power to the stage before the DC power source applies the negative voltage to the electrode plate.

12. A substrate attracting method as claimed in claim 10, having a high frequency electrical power application step of a high frequency power source connected to the stage applying high frequency electrical power to the stage before the DC power source applies the negative voltage to the electrode plate.

13. A computer-readable storage medium storing a program for causing a computer to implement a substrate attracting method for a substrate processing apparatus comprising a housing chamber in which a substrate is housed, and a stage that is disposed in the housing chamber and on which the substrate is mounted, the stage having in an upper portion thereof an electrostatic chuck comprising an insulating member having an electrode plate therein, and the electrode plate having a DC power source connected thereto, the program having
a negative voltage application module for the DC power source applying a negative voltage to the electrode plate when the substrate is to be attracted by the electrostatic chuck.
